(19) United States
(12) Patent Application Publication
(10) Pub. No.: US 2005/0255002 A1
(43) Pub. Date: Nov. 17, 2005

(54) Fast thermal activity interpreter

(75) Inventor: Hans K. Fauske, Burr Ridge, IL (US)

Correspondence Address: Joseph C. Spadacene;Westinghouse Electric Company LLC, 4350 Northern Pike, Monroeville, PA, 15146, US

(73) Assignee: Westinghouse Electric Company LLC

(21) Appl. No.: 11/125,642

(22) Filed: May 10, 2005

Related U.S. Application Data
(60) Provisional application No. 60/570,025, filed on May 11, 2004.

(51) Int. Cl. G01N 31/12

(52) U.S. Cl. 422/78

(57) ABSTRACT

A fast thermal activity interpreter instrument (10) useful to determine the stability of a chemical compound sample (13) subject to gassy decomposition or gas consuming oxidation, contains an isothermal liquid bath (14), a leak tight test cell (12) containing the sample (13), and a differential pressure transducer (11), for measuring differential pressures connected with the test cell (12).

### CROSS-REFERENCE TO RELATED APPLICATION

The instant application claims priority based upon U.S. Provisional Application No. 60/570,025 filed on May 11, 2004.

### FIELD OF THE INVENTION

The present invention relates to a thermal activity interpreter (“FTAI”) for determining the stability of a chemical compound subject to gaseous decomposition.

In contrast to utilizing expensive and time consuming microwatt calorimetry the FTAI invention is a simple isothermal meter providing the rate of pressure change for chemicals undergoing gaseous decomposition reactions. Thermal activity (“TA”) values of the order of 1 μW/g or self-heat rate of the order of 10.⁻⁵° C./min can be interpreted from the measured pressure change. Recognizing the need for frequent sampling, the thermal activity interpreter (“FTAI”) takes about 1 to 2 hours to run an analysis.

The FTAI also provides an easy means for determining activation energies and rate laws of gaseous decomposition reactions at ambient temperature conditions and is also well suited to measure material oxidation or corrosion reaction rates involving oxygen consumption.

### BACKGROUND OF THE INVENTION

Effective process safety management (“PSM”) requires the ability to measure and control key action characteristics. In case of storage and/or transportation of large bulk quantities of self-reactive chemicals, the rate of heat evolution or thermal activity, TA, near ambient temperature condition is the most significant factor in determining safe operating envelopes. TA's as low as 1 μW/g are of practical interest in many cases involving chemicals undergoing desirable gassy reactions. Available thermal activity monitors (“TAMs”) utilizing micro-calorimetry heat flow techniques capable of measuring such small activities or TA values (μW/g) are understandably very expensive (in excess of $100,000.00) and time consuming (16 hours or more per sample analysis).

Considering that the material thermal activity or the TA value can be quite sensitive to small amounts of various forms of contamination, (metals, moisture, etc.), product control measures require frequent measurements during material production, storage, loading and transportation. By assuring that the product TA value is kept below a specified value, storage size and allowable transportation time can be defined to prevent the occurrence of uncontrollable runaway reactions.

Given the need for frequent TA measurements at various times and locations associated with production, storage and transportation, a new quick concept is desirable for chemicals undergoing gassy decomposition reactions. This concept can be based upon measuring the pressure increase associated with the gas generation rate. It is also desirable to reduce the cost (to about $20,000.00) as well as the measurement time to about 1 hr. The TA values obtained should be consistent with values resulting from direct heat flow micro-calorimetry measurements. The new concept should also provide an easy means for determining activation energies and rate laws of gaseous decomposition reactions at ambient temperature conditions, and be well suited to measure material oxidation or corrosion reactions rates involving gas consumption.

### SUMMARY OF THE INVENTION

The above need for a new concept to determine the stability of a chemical compound subject to gassy decomposition or gas consuming oxidation reactions is met by providing a fast thermal activity interpreter (“FTAI”) comprising: an isothermal liquid bath controlled to within about 0.01° C. of a desired temperature; a leak tight container disposed in the liquid bath for containing the chemical compound; and a differential pressure transducer operably connected with the leak tight container for measuring differential pressures as low as 100 Pascal (Pa) in the container.

The invention also resides in the following methods of using the FTAI described above:
(a) to infer the rate of heat evolution of a gassy material as a function of the time rate of pressure rise at a specified isothermal temperature condition;
(b) to infer the activation energy of a gassy material from changes in pressure with time at two different isothermal temperature conditions; and
(c) to develop rate laws for both gas-producing and gas-consuming reactions, leading to estimates of times of adiabatic runaway, T_{SADT} or critical size, pyrophoricity potential, and half life.

The FTAI is an especially designed instrument to monitor chemical systems undergoing gaseous decomposition reactions with the capability of interpreting TA's of the order of 1 μW/g or a self heat rate of the order of 10.⁻⁵° C.min⁻¹. Recognizing the need for frequent sampling, the TAI takes about 1 hour to run an analysis.

The FTAI concept provides an easy means for determining activation energies and rate laws of gaseous decomposition reactions at ambient temperature conditions and is also well suited to measure material oxidation or corrosion reaction rates involving oxygen consumption.

### BRIEF DESCRIPTION OF THE DRAWINGS

To better understand the invention, reference may be made to the preferred non-limiting embodiments exemplary of the invention shown in the following drawings, in which:

FIG. 1 is a schematic view, partly in section of a TAI instrument including one embodiment of a test cell pressure transducer with associated auxiliaries such as an integral printed circuit board (“PCB”) including an analog to digital converter (“ADC”) web server and printer connections;

FIG. 2 is a graph of FTAI, 50% H₂O₂ test data at 40° C. isothermal operation with pressure (psig) vs time (sec); and

FIG. 3 illustrates a graph of vessel diameter vs. self acceleration decomposition temperature for 50% H₂O₂ solution.

### DETAILED DESCRIPTION OF THE PREFERRED EMBODIMENTS

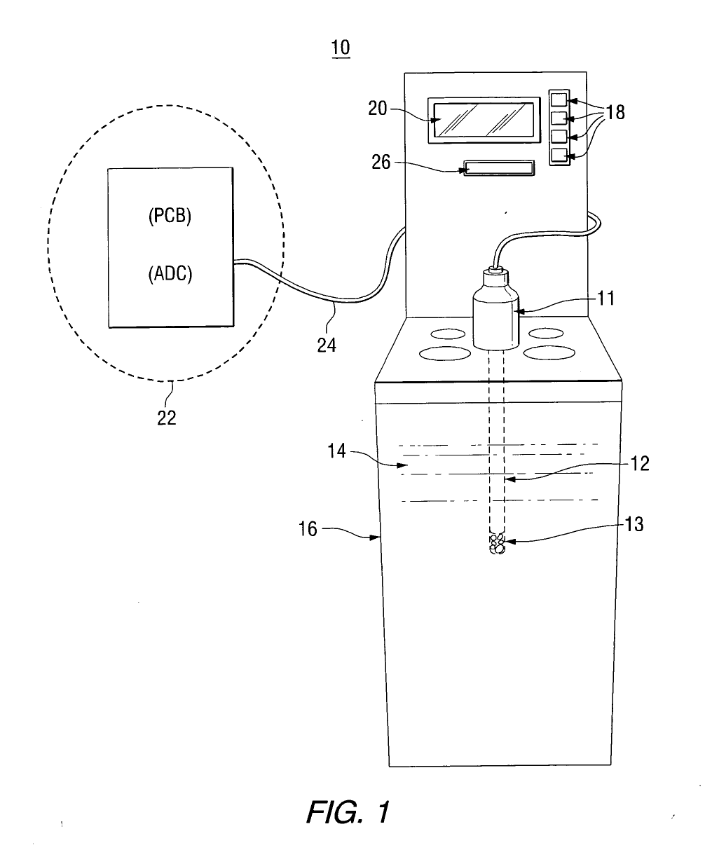

The FTAI instrument 10 shown in FIG. 1 is designed to provide a quick assessment of the sample thermal activity. A pressure transducer 11 having a sample test cell 12 holder is shown in FIG. 1. The reactive sample 13 (liquid or powder) is placed in the leak-tight test cell 12 (≈50 ml or less), preferably substantially made of glass, and submerged in a specially designed stirred liquid bath, generally shown at 14 contained within the FTAI cabinet 16, which provides isothermal sample conditions to within 001° C. of the desired temperature. The isothermal bath liquid can be, for example, water, preferably distilled water, a mixture of water and ethylene glycol (water 50% to 70%), silicone oil, or other “water like” liquids. The choice depends upon the desired isothermal bath temperature required.

As shown in FIG. 1, the differential pressure transducer 11 is connected directly to the glass test cell 12 which is capable of measuring differential pressures as low as of the order of 100 Pa.

(100 Pa≈1 cm of H₂O 10³ bar≈0.015 psi.) The pressure change in the sample holder test cell 12, due to temperature variation in the liquid bath (0.01° C.) at atmospheric pressure and 40° C., is no more than about 3 Pa. Pressure variation due to chemical heating of the sample during a 1 hr. period is also negligible for any TA value of practical interest. Sample heatup corresponding to 100 Pa change in pressure for one hour isothermal operation is about 2.10⁻³° C., which corresponds to a pressure change of only about 1 Pa. Thus, the measured pressure generation is due only to the gas evolution resulting from the chemical heat production rate. This observation applies to both gas producing and gas consuming reactions. As discussed further below, the measured pressure change can be used to automatically calculate thermal activity in TA units (μW/g).

One embodiment of the FTAI system of this invention, is shown in FIG. 1, where the FTAI cabinet 16 contains user controls 18, such as buttons; an LCD 20 for setting test conditions and monitor the results, and a computer 22, shown as operably connected by cable or the like with the pressure transducer 11. This computer can contain a printed circuit board (“PCB”), including an analog to digital converter (“ADC”), with web server and printer connections. A Means 26 is used for storage of test results.

With the FTAI test cell half full with sample liquid or full with sample powder (porosity ˜0.5), the self heat rate \dot{T}(° C.min⁻¹) can be inferred from the measured rate of pressure rise, \dot{P}(Pa min⁻¹)

$$\dot{T} = N \frac{{M}_{w , s} Δ {H}_{R} \dot{P}}{{N}_{g} ρ CRT} \qquad ( 1 )$$

where
M_{w,s} (kg/kg mole)=molecular weight of sample,
ΔH_{R} (J kg⁻¹)=heat of reaction,
N_{g}=mole gas/mole sample,
ρ (kg m⁻³)=sample density,
C (J kg⁻¹K⁻¹)=sample specific heat
R (8,314 Pa-m³/K-kg mole)=gas constant,
T (K)=isothermal sample temperature
or in terms of TA value

$$TA ( μ W / g ) = \frac{{10}^{3} {M}_{W , 5} Δ {H}_{R} \dot{P}}{60 {N}_{g} ρ RT} \qquad ( 2 )$$

For a large number of gassy reactions, the variation in the intrinsic property group (M_{w,s} ΔH_{R}/N_{g} ρ) is only about a factor of 2. Setting T=313 K, a first order estimate of the TA value is
TA(μW/g)≈P(Pa min⁻¹) (3)
(If the property group value is known, Eq. 2 provides the estimate of the TA value. Also if not available, the FTAI can be calibrated for a given material whose TA value has been established from available micro-calorimetry heat flow measurements.)

Given the inability to accurately measure pressure changes of the order 100 Pa, extremely low TA values or corresponding self heat rates can be inferred depending upon the isothermal test duration, as illustrated below in Table 1.

TABLE 1
TA Values Inferred From Eq (3)

| Isothermal | TA | Self Heat Rate |
|---|---|---|
| Test Duration | μW/g | ° C. min⁻¹ |
| 1 hr. | 1.7 | 4 · 10⁻⁵ |
| 12 hrs. | 0.14 | 3.3 · 10⁻⁶ |
| 24 hrs. | 0.07 | 1.7 · 10⁻⁶ |
| 7 days | 0.01 | 2.4 · 10⁻⁷ |

An illustration of the FTAI concept for gaseous decomposition reactions use is made of the decomposition of H₂O₂

$${H}_{2} {O}_{2} -> {H}_{2} O + \frac{1}{2} {O}_{2} \qquad ( 4 )$$

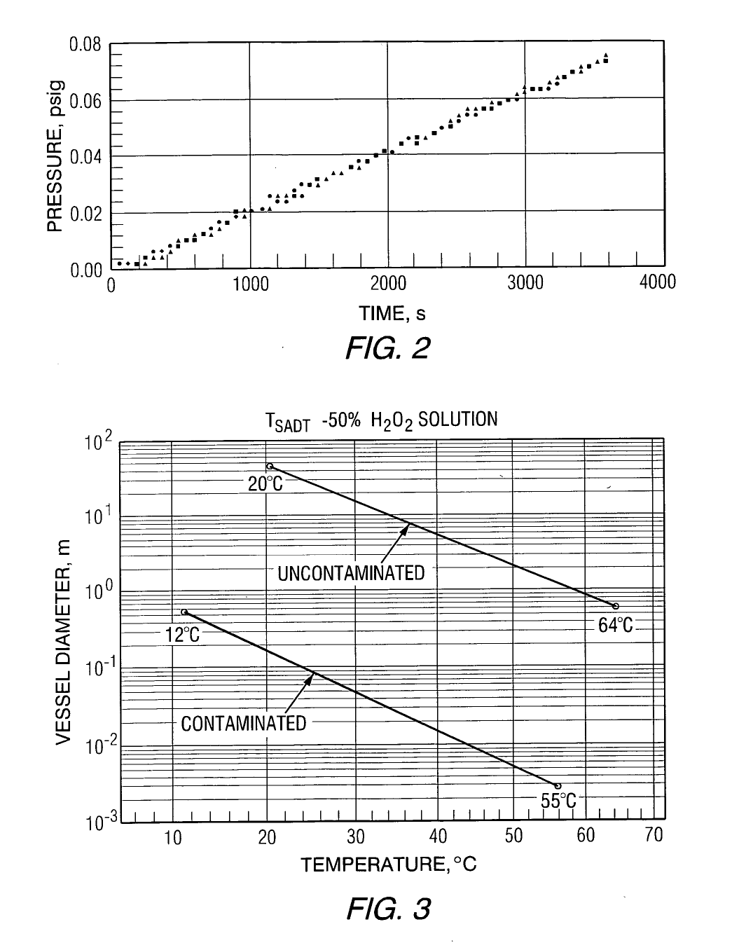

Two one hour data sets obtained with the FTAI test cell half full with 50% H₂O₂ solution at 40° C. isothermal operation are shown in FIG. 2 of the drawings. Excellent reproducibility is illustrated with an average slope of 1.2·10⁻³ psi/min or 8.2 Pa min⁻¹. Setting M_{WS}=34 kg/kg mole, ΔHₚ=2.88·10⁶ Jkg⁻¹, N_{g}=0.5 molegas/molesample, ρ=1410 kgm⁻³, T=313 K and ρ=8.2 Pa min⁻¹, Eq. 2 leads to TA=7.3 μW_{g} or from Eq. 3, TA=8.2 μW_{g}. As indicated earlier, detecting heat flow of this magnitude requires micro-calorimetry which is very expensive and time consuming. The noted difference between 7.3 and 8.2 μW_{g} is not significant considering the decomposition rate is highly sensitive to minute contaminations such as metals etc.

Information obtained from FTAI measurements can be used to evaluate characteristic time of adiabatic runaway.

$$t = \frac{{T}_{o}^{2}}{\dot{T} B} \qquad ( 5 )$$

Runaway times are of immediate interest to both storage and transportation. If they are much larger than the exposure times, even assuming adiabatic conditions, the situation can be judged to be immediately safe. However, in many practical cases it is of interest to consider non-adiabatic conditions as discussed below.

Effective management of reactive chemical hazards would benefit from always recognizing that thermal or chemical stability in contrast to classical safety data such as flash points, explosion limits, etc., is not an absolute quantity that can be assigned to a given chemical.

As an example, chemical stability or the absence of hazardous reaction runaway condition can be described in terms of the so-called self acceleration decomposition temperature (SADT) which varies depending upon the heat dissipation rate. This means that even a very weak initial chemical heat evolution rate may lead to a hazard if it takes place in an environment prone to heat accumulation.
For viscous and solid materials

$${T}_{SADT}^{2} = \frac{{R}^{2} B}{{δ}_{c} α} A {ⅇ}^{- B / {T}_{SADT}} \qquad ( 6 )$$

where T_{SADT} (K) is the SADT (reaction heat equals heat loss), R(m) is the radius of the material, α(m²s⁻¹) is the thermal diffusivity of material, δ_{c}=3.32 for sphere; =2.37 for cylinder H=3R; =2.00 for infinite cylinder; =0.88 for infinite slab with diameter=2R, A (K s⁻¹) is the pre-exponential factor, B (K) is the activation temperature, and for non-viscous liquids.

$${T}_{SADT}^{2} = \frac{V ρ cB}{hS} A {ⅇ}^{1 - {BIT}_{SADT}} \qquad ( 7 )$$

Where V (m³) is the volume of the material, ρ(kg m⁻³) is the density of material, c (Jkg⁻¹K⁻¹) is the specific heat of material, h (Wm⁻²K⁻¹) is the effective heat transfer coefficient, and S (m²) is the surface area. As discussed above, values of A and B for gassy reactions are easily provided by the FTAI concept.

A hypothetical example of T_{SADT} for 50% H₂O₂ solution is illustrated in FIG. 3 based upon Eq. 7. For a 200 liter container of uncontaminated 50% H₂O₂ solution, Eq. 7 suggests a T_{SADT} of about 64° C. FIG. 3 also illustrates the sensitivity to small amounts of contamination. An increase in the reaction rate by a factor of 500 from only about 10 ppm metal contamination is seen to reduce the T_{SADT} value for the 200 liter container to 12° C. Effective product control limiting the TA value to a safe limit, i.e. ruling out a runaway reaction hazard at temperatures of interest can be assured by frequent sampling using the TAI concept.

The concept described will provide an inexpensive and quick method to support the need for frequent product sampling at multiple locations to control potential contamination associated with storage and transportation of slowly decomposing chemicals.

The FTAI concept also provides an easy means for determining the activation energies of unknown decomposing chemicals at ambient temperature conditions, thereby eliminating the need for large extrapolations which is often the case when using adiabatic calorimetry temperature measurements. This information can be used to develop rate laws (Arrhenius expressions) for both gas producing and gas consuming (oxidation of metals etc.) reactions, leading to estimates of time of adiabatic runaway, T_{SADT} or critical size, pyrophoricity potential, and half life.

These equations and equations for also establishing the rate laws for decomposition reactions, and gas consuming reactions, are described, for example, in Process Safety Progress, “A Fast Thermal Activity Interpreter for Controlling Chemical Reaction Hazards”: Hans K. Fauske, Vol 23, No 2, June 2004 pp 108-113, herein incorporated by reference.

1. A fast thermal activity interpreter for determining the stability of a chemical compound subject to gassy decomposition or gas-consuming oxidation reactions, comprising:
an isothermal liquid bath;
a leak-tight container disposed in the liquid bath for containing the chemical compound; and
a differential pressure transducer operably connected with the leak-tight container for measuring differential pressures as low as 100 Pascal in the container.

2. The fast thermal activity interpreter of claim 1, wherein the isothermal liquid bath is controlled to within about 0.01° C. of a desired temperature.

3. The fast thermal activity interpreter of claim 1, wherein the interpreter is capable of determining thermal activity values of the order of 1 μW/g.

4. The fast thermal activity interpreter of claim 1, wherein the interpreter is capable of running an analysis in from 1 to 2 hours.

5. The fast thermal activity interpreter of claim 1, wherein the leak-tight container is made substantially of glass.

6. The fast thermal activity interpreter of claim 1, wherein the isothermal liquid bath is selected from the group consisting of water-like liquids.

7. The fast thermal activity interpreter of claim 1, wherein a computer is operably connected with the pressure transducer.

8. The fast thermal activity interpreter of claim 1, wherein the isothermal liquid bath is selected from the group consisting of water, mixtures of water and ethylene glycol and silicone oil.

9. The fast thermal activity interpreter of claim 2, wherein the pressure change in the leak tight container due to temperature variation in the liquid bath is no more than about 3 Pascal.

10. The method of using the fast thermal activity interpreter of claim 1, to infer the rate of heat evolution of a gassy material as a function of the rate of pressure rise at a specified isothermal temperature condition.

11. The method of using the fast thermal activity interpreter of claim 1, to infer the activation energy of a gassy material from changes in pressure with time at two different isothermal temperature conditions.

12. The method of using the fast thermal activity interpreter of claim 1, to develop ratelaws for both gas-producing and gas-consuming reactions, leading to estimates of times of adiabatic runaway, T_{SADT} or critical size, pyrophoricity potential, and half life.
